(19) United States
(12) Patent Application Publication
(10) Pub. No.: US 2017/0015029 A1
(43) Pub. Date: Jan. 19, 2017

(54) Injection Molding with a Leaking Check Ring

(71) Applicant: iMFLUX Inc., Cincinnati, OH (US)

(72) Inventors: Gene Michael ALTONEN, West Chester, OH (US); Randy Lee HUGHES, Manchester, OH (US); Chow-chi HUANG, West Chester, OH (US); Brandon Michael BIRCHMEIER, Morrow, OH (US); Herbert Kenneth HANSON, III, Cincinnati, OH (US)

(21) Appl. No.: 15/211,330

(22) Filed: Jul. 15, 2016

Related U.S. Application Data
(60) Provisional application No. 62/192,616, filed on Jul. 15, 2015.

(51) Int. Cl. B29C 45/00

(52) U.S. Cl. CPC B29C 45/0003; B29K 2101/12

(57) ABSTRACT

Injection molding at substantially constant pressure yields a substantially controlled injection molding process, even when utilizing a leaking check ring.

### TECHNICAL FIELD

This disclosure relates generally to apparatuses and methods for injection molding and, more particularly, to apparatuses and methods for performing injection molding at substantially constant injection pressure, which provides a substantially controlled injection molding process even when utilizing a leaking check ring.

### BACKGROUND

Injection molding is a technology commonly used for high-volume manufacturing of parts made of thermoplastic material. During a repetitive injection molding process, a thermoplastic resin, most often in the form of small beads or pellets, is introduced to an injection molding machine that melts the resin beads under heat and pressure. The now-molten resin is forcefully injected into a mold cavity having a particular cavity shape. The injected plastic is held under pressure in the mold cavity, cooled, and then removed as a solidified part having a shape that essentially duplicates the cavity shape of the mold. The mold itself may have a single cavity or multiple cavities.

An injection molding cycle, as used herein, or simply “cycle”, can include the steps of (1) melting a shot of polymeric material; (2) clamping together two (or more) portions of a mold, such as a mold core and a mold cavity plate, that together form the mold walls that define one or more mold cavities (typically while the mold walls are in a cool condition relative to the temperature to which the molten thermoplastic material is heated prior to injection into the mold cavity); (3) injecting molten polymeric material into the one or more mold cavities; (4) coining the molten polymeric material, i.e., filling the one or more mold cavities a pre-determined amount and then fully closing the mold, thereby compressing the molten polymeric material to fully fill the one or more cavities; (5) waiting some period of time until the molded polymeric material cools to a temperature sufficient to eject the part, i.e. a temperature below its melt temperature, so that at least outside surfaces of the molded part are sufficiently solid so that the part will maintain its molded shape once ejected; (6) opening the portions of the mold that define the one or more mold cavities; (7) ejecting the molded part(s) from the one or more mold cavities; and (8) closing the two (or more) mold sections (for a subsequent cycle).

### SUMMARY OF THE INVENTION

The present disclosure describes injection molding at substantially constant pressure, and preferably, at substantially constant pressure of 15,000 psi and lower, in some cases, 10,000 psi and lower, while continuing to mold past a point when a check ring of the injection molding system leaks to a degree such that conventional molding would require molding at excessive pressures to maintain the desired screw velocity, all without negatively affecting part quality.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 illustrates a schematic view of a constant pressure injection molding machine constructed according to the disclosure;

FIG. 2 is a cross-sectional view of a barrel of an injection molding system of the present disclosure;

FIGS. 3A-3D illustrate a first injection molding cycle of an injection molding run performed using an injection molding system of the present disclosure;

FIGS. 3E-3H are close-up views of portions of FIGS. 3A-3D, respectively;

FIGS. 4A-4D illustrate a second injection molding cycle of the injection molding run performed using an injection molding system of the present disclosure and performed with a leaking check ring;

FIGS. 4E-4H are close-up views of portions of FIGS. 4A-4D, respectively.

### DETAILED DESCRIPTION OF THE INVENTION

Embodiments of the present invention generally relate to systems, machines, products, and methods of producing products by injection molding and more specifically to systems, products, and methods of producing products by low substantially constant pressure injection molding.

The term “low pressure” as used herein with respect to melt pressure of a thermoplastic material, means melt pressures in a vicinity of a nozzle of an injection molding machine of 15,000 psi and lower.

The term “substantially constant pressure” as used herein with respect to a melt pressure of a thermoplastic material, means that deviations from a baseline melt pressure do not produce meaningful changes in physical properties of the thermoplastic material. For example, “substantially constant pressure” includes, but is not limited to, pressure variations for which viscosity of the melted thermoplastic material do not meaningfully change. The term “substantially constant” in this respect includes deviations of approximately 30% from a baseline melt pressure. For example, the term “a substantially constant pressure of approximately 4600 psi” includes pressure fluctuations within the range of about 6000 psi (30% above 4600 psi) to about 3200 psi (30% below 4600 psi). A melt pressure is considered substantially constant as long as the melt pressure fluctuates no more than 30% from the recited pressure. The melt pressure may, for example, fluctuate no more than 25% of the recited pressure, no more than 20% of the recited pressure, no more than 15% of the recited pressure, no more than 10% of the recited pressure, no more than 5% of the recited pressure, or some other percentage or fraction between 0% and 30%. A melt pressure is considered substantially constant as long as the melt pressure is maintained for 30% to 95% of the filling of a mold cavity. The melt pressure may, for example, be maintained for 50% to 95% of the filling of the mold cavity, 60% to 95% of the filling of the mold cavity, 70% to 95% of the filling of the mold cavity, 80% to 95% of the filling of the mold cavity, or some other percentage or fraction between 30 to 95%.

The term “melt holder”, as used herein, refers to the portion of an injection molding machine that contains molten plastic in fluid communication with the machine nozzle. The melt holder is heated, such that a polymer may be prepared and held at a desired temperature. The melt holder is connected to a power source, for example a hydraulic cylinder or electric servo motor, that is in communication with a central control unit, and can be controlled to advance a diaphragm to force molten plastic through the machine nozzle. The molten material then flows through the runner system into the mold cavity. The melt holder may be cylindrical in cross section, or have alternative cross sections that will permit a diaphragm to force polymer under pressures that can range from as low as 100 psi to pressures 40,000 psi or higher through the machine nozzle. The diaphragm may optionally be integrally connected to a reciprocating screw with flights designed to plasticize polymer material prior to injection.

The term “peak flow rate” generally refers to the maximum volumetric flow rate, as measured at the machine nozzle.

The term “peak injection rate” generally refers to the maximum linear speed the injection ram travels in the process of forcing polymer in to the feed system. The ram can be a reciprocating screw such as in the case of a single stage injection system, or a hydraulic ram such as in the case of a two stage injection system.

The term “ram rate” generally refers to the linear speed the injection ram travels in the process of forcing polymer into the feed system.

The term “flow rate” generally refers to the volumetric flow rate of polymer as measured at the machine nozzle. This flow rate can be calculated based on the ram rate and ram cross sectional area, or measured with a suitable sensor located in the machine nozzle.

The term “cavity percent fill” generally refers to the percentage of the cavity that is filled on a volumetric basis. For example, if a cavity is 95% filled, then the total volume of the mold cavity that is filled is 95% of the total volumetric capacity of the mold cavity.

The term “melt temperature” generally refers to the temperature of the polymer that is maintained in the melt holder, and in the material feed system when a hot runner system is used, which keeps the polymer in a molten state. The melt temperature varies by material. However, a desired melt temperature is generally understood to fall within the ranges recommended by the material manufacturer.

The term “gate size” generally refers to the cross sectional area of a gate, which is formed by the intersection of the runner and the mold cavity. For hot runner systems, the gate can be of an open design where there is no positive shut off of the flow of material at the gate, or a closed design where a valve pin is used to mechanically shut off the flow of material through the gate in to the mold cavity (commonly referred to as a valve gate). The gate size refers to the cross sectional area, for example a 1 mm gate diameter refers to a cross sectional area of the gate that is equivalent to the cross sectional area of a gate having a 1 mm diameter at the point the gate meets the mold cavity. The cross section of the gate may be of any desired shape.

The term “effective gate area” generally refers to a cross sectional area of a gate corresponding to an intersection of the mold cavity and a material flow channel of a feed system (e.g., a runner) feeding thermoplastic to the mold cavity. The gate could be heated or not heated. The gate could be round, or any cross sectional shape, suited to achieve the desired thermoplastic flow into the mold cavity.

The term “intensification ratio” generally refers to the mechanical advantage the injection power source has on the injection ram forcing the molten polymer through the machine nozzle. For hydraulic power sources, it is common that the hydraulic piston will have a 10:1 mechanical advantage over the injection ram. However, the mechanical advantage can range from ratios much lower, such as 2:1, to much higher mechanical advantage ratios, such as 50:1.

The term “peak power” generally refers to the maximum power generated when filling a mold cavity. The peak power may occur at any point in the filling cycle. The peak power is determined by the product of the plastic pressure as measured at the machine nozzle multiplied by the flow rate as measured at the machine nozzle. Power is calculated by the formula P=p*Q where p is pressure and Q is volumetric flow rate.

The term “volumetric flow rate” generally refers to the flow rate as measured at the machine nozzle. This flow rate can be calculated based on the ram rate and ram cross sectional area, or measured with a suitable sensor located in the machine nozzle.

The terms “filled” and “full,” when used with respect to a mold cavity including thermoplastic material, are interchangeable and both terms mean that thermoplastic material has stopped flowing into the mold cavity.

The term “shot size” generally refers to the volume of polymer to be injected from the melt holder to completely fill the mold cavity or cavities. The shot size is determined based on the temperature and pressure of the polymer in the melt holder just prior to injection. In other words, the shot size is a total volume of molten plastic material that is injected in a stroke of an injection molding ram at a given temperature and pressure. Shot size may include injecting molten plastic material into one or more injection cavities through one or more gates. The shot of molten plastic material may also be prepared and injected by one or more melt holders.

The term “hesitation” generally refers to the point at which the velocity of the flow front is minimized sufficiently to allow a portion of the polymer to drop below its no-flow temperature and begin to freeze off.

The term “electric motor” or “electric press,” when used herein, includes both electric servo motors and electric linear motors.

The term “Peak Power Flow Factor” refers to a normalized measure of peak power required by an injection molding system during a single injection molding cycle and the Peak Power Flow Factor may be used to directly compare power requirements of different injection molding systems.

The Peak Power Flow Factor is calculated by first determining the peak power, which corresponds to the maximum product of molding pressure multiplied by flow rate during the filling cycle (as defined herein), and then determining the shot size for the mold cavities to be filled. The Peak Power Flow Factor is then calculated by dividing the peak power by the shot size.

The term “low constant pressure injection molding machine” is defined as a class 101 or a class 30 injection molding machine that uses a substantially constant injection pressure that is less than 15,000 psi. Alternatively, the term “low constant pressure injection molding machine” may be defined as an injection molding machine that uses a substantially constant injection pressure that is less than 15,000 psi and that is capable of performing more than 1 million cycles, preferably more than 1.25 million cycles, more preferably more than 2 million cycles, more preferably more than 5 million cycles, and even more preferably more than 10 million cycles before the mold core (which is made up of first and second mold parts that define a mold cavity therebetween) reaches the end of its useful life. Characteristics of “low constant pressure injection molding machines” include mold cavities having an L/T ratio of greater than 100 (and preferably greater than 200), multiple mold cavities (preferably 4 mold cavities, more preferably 16 mold cavities, more preferably 32 mold cavities, more preferably 64 mold cavities, more preferably 128 mold cavities and more preferably 256 mold cavities, or any number of mold cavities between 4 and 512), a heated runner, and a guided ejection mechanism.

The term “useful life” is defined as the expected life of a mold part before failure or scheduled replacement. When used in conjunction with a mold part or a mold core (or any part of the mold that defines the mold cavity), the term “useful life” means the time a mold part or mold core is expected to be in service before quality problems develop in the molded part, before problems develop with the integrity of the mold part (e.g., galling, deformation of parting line, deformation or excessive wear of shut-off surfaces), or before mechanical failure (e.g., fatigue failure or fatigue cracks) occurs in the mold part. Typically, the mold part has reached the end of its “useful life” when the contact surfaces that define the mold cavity must be discarded or replaced. The mold parts may require repair or refurbishment from time to time over the “useful life” of a mold part and this repair or refurbishment does not require the complete replacement of the mold part to achieve acceptable molded part quality and molding efficiency. Furthermore, it is possible for damage to occur to a mold part that is unrelated to the normal operation of the mold part, such as a part not being properly removed from the mold and the mold being force ably closed on the non-ejected part, or an operator using the wrong tool to remove a molded part and damaging a mold component. For this reason, spare mold parts are sometimes used to replace these damaged components prior to them reaching the end of their useful life. Replacing mold parts because of damage does not change the expected useful life.

The term “guided ejection mechanism” is defined as a dynamic part that actuates to physically eject a molded part from the mold cavity.

The term “coating” is defined as a layer of material less than 0.13 mm (0.005 in) in thickness, that is disposed on a surface of a mold part defining the mold cavity, that has a primary function other than defining a shape of the mold cavity (e.g., a function of protecting the material defining the mold cavity, or a function of reducing friction between a molded part and a mold cavity wall to enhance removal of the molded part from the mold cavity).

The term “average hardness” is defined as the Rockwell hardness for any material or combination of materials in a desired volume. When more than one material is present, the average hardness is based on a volume weighted percentage of each material. Average hardness calculations include hardnesses for materials that make up any portion of the mold cavity. Average hardness calculations do not include materials that make up coatings, stack plates, gates, or runners, whether integral with a mold cavity or not, and support plates. Generally, average hardness refers to the volume weighted hardness of material in the mold cooling region.

The term “mold cooling region” is defined as a volume of material that lies between the mold cavity surface and an effective cooling surface.

The term “cycle time” is defined as a single iteration of an injection molding process that is required to fully form an injection molded part. Cycle time includes the collective time it takes to perform the steps of advancing molten thermoplastic material into a mold cavity, substantially filling the mold cavity with thermoplastic material, coining the thermoplastic material, cooling the thermoplastic material, separating first and second mold sides to expose the cooled thermoplastic material, removing the thermoplastic material, and closing the first and second mold sides.

The term “skin” or “skin layer” is defined as a surface layer of a molded part. While it is recognized that skin or skin layer can be considered in the context of a molded part's surface aesthetics, which may include the texture or finish of the part, and thus have a depth on the order of only 5% of the wall thickness, when considering the skin layer as it relates to most mechanical properties of a molded part, the skin layer may include the outer 20% of the part.

The term “flow front” refers to a leading edge of a shot of molten polymeric material, as experienced by the surfaces of the mold that define a mold cavity, as the molten polymeric material is progressing from a nozzle or gate of the mold cavity (i.e., a point or points of introduction of the molten polymeric material into the mold cavity) toward, and ultimately to, an end-of-fill location of the mold cavity.

The term “upstream” refers to a relative location in a mold cavity that a flow front progressing through the mold cavity reaches prior to a given reference location, such that if a flow front of thermoplastic material in a mold cavity reaches location X prior to location Y of the mold cavity as the flow front progresses through the mold cavity, it is said that location X is upstream of location Y. The given reference location may, for example, be a gate, part of the mold (e.g., one of the walls), a coining element (e.g., a core), or a flow location (e.g., end-of-fill location).

The term “downstream” refers to a relative location in a mold cavity that a flow front progressing through the mold cavity reaches after passing a given reference location, such that if a flow front of thermoplastic material in a mold cavity reaches location Z after location Y of the mold cavity as the flow front progresses through the mold cavity, it is said that location Z is downstream of location Y. The given reference location may, for example, be a gate, part of the mold (e.g., one of the walls), a coining element (e.g., a core), or a flow location (e.g., end-of-fill location).

The term “surface area of the mold” refers to the collective area of the surfaces of the mold that together form the mold walls defining one or more mold cavities, to the extent thermoplastic material injected into the mold cavity is exposed to those surfaces in order to form a full molded part.

As used herein, the term “production version” refers to an injection molded part that is a “quality molded article.”

As used herein, the term “quality molded article” refers to a molded article that satisfies one or more predetermined dimensional, performance, and/or aesthetic requirements within a defined tolerance range and is generally free of defects. Such dimensional requirements can include, but are not limited to, part lengths, widths, path lengths or perimeters, thickness, eccentricity, flatness or warp, parallelism, perpendicularity, and/or concentricity. Such performance requirements can include, but are not limited to, surviving and/or absorbing loads, such as tensile loads, compressive loads, torsional loads; exposure to vibration, surviving and/or absorbing electrical loads, and withstanding environmental exposures for a rated period of time. Additional performance requirements may include acoustic properties, such as, resonant frequencies, harmonics, and dampening behavior; and optical performance, such as percent transmission, dispersion, specularity, reflectance, and allowable aberrations. Aesthetic requirements can include, but are not limited to color, texture, surface texture, knit lines, blush, gap trap vestiges, markings, such as burn markings or freedom from undesired markings, and visible sink. Quality parts are also substantially free of defects, including, but not limited to lacking internal voids or containing only internal voids that do not compromise mechanical, electrical, or optical performance, substantially free of mold-in stress or have mold-in stress within a given tolerance, and substantially free of defects resulting from short shot or freeze-f during the molding process. Other requirements or part specification specified by a part customer are also within the contemplation of this definition. For example, the customer may require the molded article to have a given tensile and/or flexural moduli, impact resistance, hardness, chemical resistance and/or compatibility, abrasion resistance, thermal conductivity and/or resistivity, electrical conductivity and/or resistivity, reflectivity, specularity, clarity, percent transmission, index of refraction, and/or coefficient of friction.

As used herein, the term “cushion” refers to a distance from a front of a check ring to an end of a barrel at an end of the injection molding cycle. The cushion is generally based on the target shot size. When the target shot size is increased, the cushion will increase as well. Conversely, when the target shot size is decreased, the cushion will decrease as well.

As used herein, the term “backflow” refers to the amount of material that passes through a check ring in a direction from an end of the barrel toward a hopper of the injection molding apparatus.

Low constant pressure injection molding machines may also be high productivity injection molding machines (e.g., a class 101 or a class 30 injection molding machine, or an “ultra high productivity molding machine”), such as the high productivity injection molding machine disclosed in U.S. patent application Ser. No. 13/601,514, filed Aug. 31, 2012, which is hereby incorporated by reference herein, that may be used to produce thin-walled consumer products, such as toothbrush handles and razor handles. Thin walled parts are generally defined as having a high L/T ratio of 100 or more.

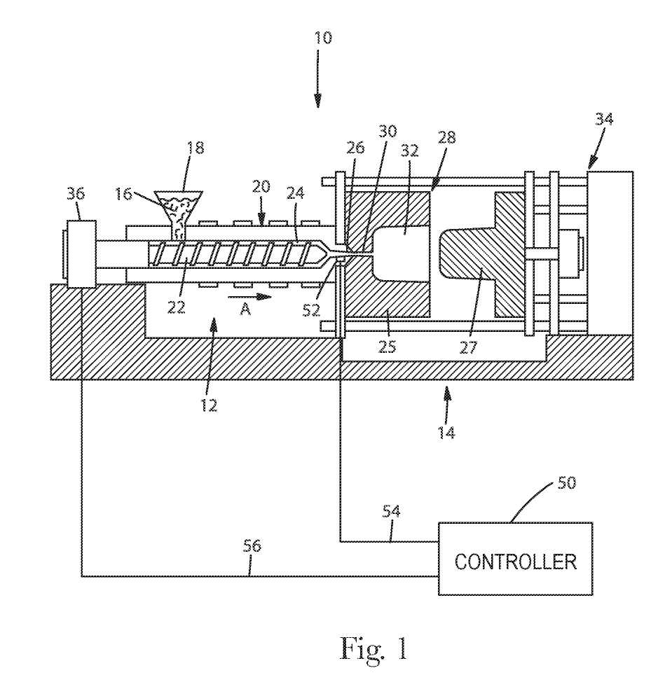

Referring to the figures in detail, FIG. 1 illustrates an exemplary low constant pressure injection molding apparatus 10 that generally includes an injection system 12 and a clamping system 14. A thermoplastic material may be introduced to the injection system 12 in the form of thermoplastic pellets 16. The thermoplastic pellets 16 may be placed into a hopper 18, which feeds the thermoplastic pellets 16 into a heated barrel 20 of the injection system 12. The thermoplastic pellets 16, after being fed into the heated barrel 20, may be driven to the end of the heated barrel 20 by a reciprocating screw 22. The heating of the heated barrel 20 and the compression of the thermoplastic pellets 16 by the reciprocating screw 22 causes the thermoplastic pellets 16 to melt, forming a molten thermoplastic material 24. The molten thermoplastic material is typically processed at a temperature of about 130° C. to about 410° C.

The reciprocating screw 22 forces the molten thermoplastic material 24 toward a nozzle 26 to form a shot of thermoplastic material, which will be injected into a mold cavity 32 of a mold 28 via one or more gates 30, preferably three or less gates, that direct the flow of the molten thermoplastic material 24 to the mold cavity 32. In other embodiments the nozzle 26 may be separated from one or more gates 30 by a feed system (not shown). The mold cavity 32 is formed between first and second mold sides 25, 27 of the mold 28 and the first and second mold sides 25, 27 are held together under pressure by a press or clamping unit 34. The press or clamping unit 34 applies a clamping force during the molding process that is greater than the force exerted by the injection pressure acting to separate the two mold halves 25, 27, thereby holding the first and second mold sides 25, 27 together while the molten thermoplastic material 24 is injected into the mold cavity 32. To support these clamping forces, the clamping system 14 may include a mold frame and a mold base.

Once the shot of molten thermoplastic material 24 is injected into the mold cavity 32, the reciprocating screw 22 stops traveling forward. The molten thermoplastic material 24 takes the form of the mold cavity 32 as the material fills the mold cavity 32. The molten thermoplastic material 24 cools inside the mold 28 until the thermoplastic material 24 solidifies. Once the thermoplastic material 24 has solidified, the press 34 releases the first and second mold sides 25, 27, the first and second mold sides 25, 27 are separated from one another, and the finished part may be ejected from the mold 28. The mold 28 may include a plurality of mold cavities 32 to increase overall production rates. The shapes of the cavities of the plurality of mold cavities may be identical, similar or different from each other. (The latter may be considered a family of mold cavities).

A controller 50 is communicatively connected with a sensor 52, located in the vicinity of the nozzle 26, and a screw control 36. The controller 50 may include a microprocessor, a memory, and one or more communication links. The controller 50 may also be optionally connected to a sensor 53 located proximate an end of the mold cavity 32. This sensor 52 may provide an indication of when the thermoplastic material is approaching the end of fill in the mold cavity 32. The sensor 52 may sense the presence of thermoplastic material optically, pneumatically, mechanically, electro-mechanically, or by otherwise sensing pressure and/or temperature of the thermoplastic material. When pressure or temperature of the thermoplastic material is measured by the sensor 52, this sensor 52 may send a signal indicative of the pressure or the temperature to the controller 50 to provide a target pressure for the controller 50 to maintain in the mold cavity 32 (or in the nozzle 26) as the fill is completed. This signal may generally be used to control the molding process, such that variations in material viscosity, mold temperatures, melt temperatures, and other variations influencing filling rate, are adjusted by the controller 50. These adjustments may be made immediately during the molding cycle, or corrections can be made in subsequent cycles. Furthermore, several signals may be averaged over a number of cycles and then used to make adjustments to the molding process by the controller 50. The controller 50 may be connected to the sensor 52, and/or the sensor 53, and the screw control 36 via wired connections 54, 56, respectively. In other embodiments, the controller 50 may be connected to the sensors 52, 53 and screw control 36 via a wireless connection, a mechanical connection, a hydraulic connection, a pneumatic connection, or any other type of communication connection known to those having ordinary skill in the art that will allow the controller 50 to communicate with both the sensors 52, 53 and the screw control 36.

In the embodiment of FIG. 1, the sensor 52 is a pressure sensor that measures (directly or indirectly) melt pressure of the molten thermoplastic material 24 in vicinity of the nozzle 26. The sensor 52 generates an electrical signal that is transmitted to the controller 50. The controller 50 then commands the screw control 36 to advance the screw 22 at a rate that maintains a desired melt pressure of the molten thermoplastic material 24 in the nozzle 26. While the sensor 52 may directly measure the melt pressure, the sensor 52 may also indirectly measure the melt pressure by measuring other characteristics of the molten thermoplastic material 24, such as temperature, viscosity, flow rate, etc., which are indicative of melt pressure. Likewise, the sensor 52 need not be located directly in the nozzle 26, but rather the sensor 52 may be located at any location within the injection system 12 or mold 28 that is fluidly connected with the nozzle 26. If the sensor 52 is not located within the nozzle 26, appropriate correction factors may be applied to the measured characteristic to calculate an estimate of the melt pressure in the nozzle 26. The sensor 52 need not be in direct contact with the injected fluid and may alternatively be in dynamic communication with the fluid and able to sense the pressure of the fluid and/or other fluid characteristics. In yet other embodiments, the sensor 52 need not be disposed at a location that is fluidly connected with the nozzle. Rather, the sensor 52 could measure clamping force generated by the clamping system 14 at a mold parting line between the first and second mold parts 25, 27. In one aspect the controller 50 may maintain the pressure according to the input from sensor 52. Alternatively, the sensor 52 could measure an electrical power demand by an electric press, which may be used to calculate an estimate of the pressure in the nozzle.

Although an active, closed loop controller 50 is illustrated in FIG. 1, other pressure regulating devices may be used instead of the closed loop controller 50. For example, a pressure regulating valve (not shown) or a pressure relief valve (not shown) may replace the controller 50 to regulate the melt pressure of the molten thermoplastic material 24. More specifically, the pressure regulating valve and pressure relief valve can prevent overpressurization of the mold 28. Another alternative mechanism for preventing overpressurization of the mold 28 is an alarm that is activated when an overpressurization condition is detected.

In a substantially constant pressure injection molding system, the location of the flow front of the molten polymeric material can be detected at desired locations with the mold cavity 32. As described above, the fact that the flow front has reached a particular location in the mold cavity 32 may be detected by a sensor 52 or 53. For instance, the sensor 52 may take the form of a pressure transducer, and may use vacuum pressure. One or more temperature sensors, such as thermal resistors, could be used instead of or in addition to a pressure sensor to determine or verify that the flow front has reached a given location of a mold cavity 32. Such a sensor 52 or 53 may operate by either sensing temperature or pressure, or by sensing a lack thereof. For instance, the sensor could sense a flow of air, and upon interruption, the sensor 52 or 53 may detect that interruption and communicate to the controller 50 that the air flow has been interrupted. Alternatively or additionally, the location of the flow front may be determined based on time, screw position (e.g., monitored using a potentiometer), hydraulic pressure, the velocity of the flow front, or some other process characteristic. As an example, the location of the flow front can be determined by monitoring the screw position, which when analyzed over time, can be used to calculate the volume of thermoplastic material in the mold 28.

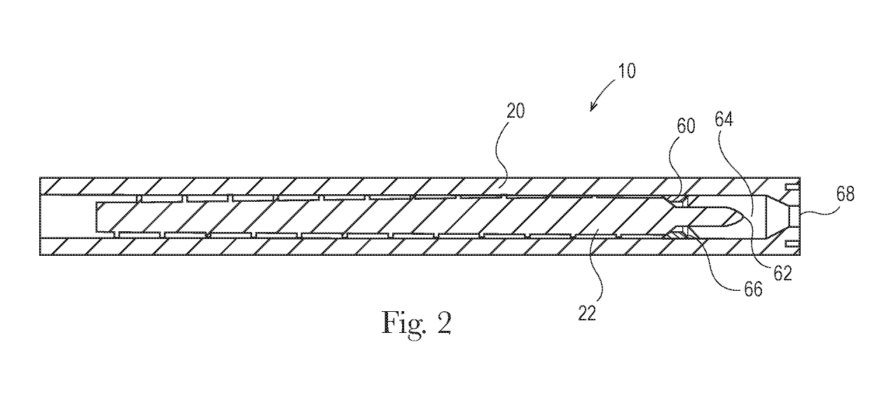

As illustrated in FIG. 2, the low constant pressure injection molding apparatus 10 further includes a check ring 60 coupled (e.g., attached) to a portion of the reciprocating screw 22 within the barrel 20. In the example illustrated in FIG. 2, the check ring 60 is coupled to the reciprocating screw 22 at a position proximate to an end 62 of the reciprocating screw 22. The check ring 60 is generally configured to prevent, or at least limit, a backflow of the molten thermoplastic material 24, i.e., the molten thermoplastic material 24 from flowing in a direction from the nozzle 26 toward the hopper 18. As an example, the check ring 60 may be configured to allow a backflow of to less than 10%, less than 9%, less than 8%, less than 7%, less than 6%, less than 5%, less than 4%, less than 3%, less than 2%, or less than 1% of the target shot size for the molten thermoplastic material 24.

Over time, however, movement of reciprocating screw 22, and thus the check ring 60 coupled thereto, tends to degrade or wear out the check ring 60. The degraded check ring 60 is, in turn, less effective at preventing, or limiting, the backflow of the molten thermoplastic material 24. At some point, it may be determined (e.g., using a dynamic check ring repeatability test or monitoring changes in a cushion size, such as by tracking changes to an end screw position, over time) that the degraded check ring 60 is no longer effectively or consistently limiting the backflow to the desired percentage of the target shot size. As an example, the check ring 60 may only be limiting the backflow to 10% of the target shot size when it is desired to limit the backflow to less than 5% of the target shot size. At this point, the check ring 60 may be classified as a “leaking” or “leaky” check ring.

Injection molding with a leaking check ring 60 will generally negatively affect the quality of molded parts. This is because, as a result of the leaking check ring 60, during subsequent injection molding cycles molten thermoplastic material 24 may end up being heated multiple times within the barrel 20, or, worse yet, the reciprocating screw 22 may “bottom out,” i.e., contact the end of the barrel 20, resulting in a pressure loss in the barrel 20.

In a conventional injection molding process, a leaking or leaky check ring 60 would typically be addressed by increasing the shot size of the molten thermoplastic material 24 for subsequent injection molding cycles. The shot size may, for example, be increased by 5%, 10%, 15%, 20%, 25%, 30%, or some integer or fraction of an integer above, below, or between those percentages, depending upon, for example, the difference between the desired amount of backflow and the amount of backflow actually being permitted by the check ring 60. For example, when the check ring 60 is allowing 5% more backflow than desired, the shot size may be increased by 5%. However, because conventional injection molding processes control with or based on velocity (at least in the first flow stage), increasing the shot size of the molten thermoplastic material 24 may actually exacerbate the problems caused by the leaky check ring 60. In a conventional molding process, increasing the shot size of the molten thermoplastic material 24 will lead to increased pressure, which will, in turn, increase slippage of the check ring 60, further increasing the amount of backflow past the already leaking check ring 60. Increased slippage will also lead to significant variations in the amount of cushion 64 provided in the barrel 22, which is measured by the distance from a front end 66 of the check ring 60 to an end 68 of the barrel 22 at the end of, or after, an injection molding cycle. Thus, the cushion 64 at the end of a first injection molding cycle may be significantly different than the cushion 64 at the end of a second injection molding cycle performed subsequent to the first injection molding cycle. As an example, the size of cushion 64 at the end of the second injection molding cycle may be 80% to 120% the size of the cushion 64 at the end of the first injection molding cycle. Cushion variability is particularly pronounced when the molten thermoplastic material 24 includes regrind, which, as is known in the art, has variable viscosity. In any event, cushion variability is generally undesirable, as it increases the chances that the cushion will be reduced to zero, in which case the reciprocating screw 22 “bottom outs,” i.e., contacts the end of the barrel 20. When this happens, the barrel 20 loses pressure, and it becomes difficult to control the quality of molded parts.

At some point, the issues associated with the leaking check ring 60 may become so problematic that it becomes desirable to instead repair or replace the leaking check ring 60 with a new, fully operational (i.e., non-leaking) check ring 60. However, doing so first requires that the injection molding apparatus 10 be shut down, thereby interrupting any injection molding runs being carried out by the injection molding apparatus 10. This, in turn, lengthens the injection molding process and may present high opportunity costs.

Unlike conventional injection molding processes, which, as discussed above, are difficult to control when the check ring 60 is leaking or “leaky,” the injection molding apparatus 10 of the present disclosure provides a substantially controlled molding process even when the check ring 60 is leaking or “leaky.” This is because the injection molding apparatus 10 of the present disclosure controls only with or based on a substantially constant low pressure (e.g., 15,000 psi and lower, 10,000 psi and lower, 6,000 psi and lower), i.e., does not control with or based on velocity. Thus, the shot size of the molten thermoplastic material 24 for subsequent injection molding cycles can be increased without causing many the negative consequences described above. Because the pressure is not increased, but instead remains substantially constant, this decreases slippage of the check ring 60, or at least minimizes the variability of any slippage, which in turn decreases cushion variability between injection molding cycles. As a result, the injection molding apparatus 10 can continue making quality molded parts, even while employing the leaking or leaky check ring 60. Moreover, because the injection molding apparatus 10 can continue making quality molded parts, the leaking check ring 60 need not be repaired or replaced as quickly as would conventionally be the case. In other words, the injection molding apparatus 10 can perform an increased number of injection molding cycles, compared to conventional injection molding apparatuses, before the leaking check ring 60 needs to be repaired or replaced. As an example, the injection molding apparatus 10 can perform 5-10% more injection molding cycles than conventional injection molding apparatuses before the leaking check ring 60 needs to be repaired or replaced.

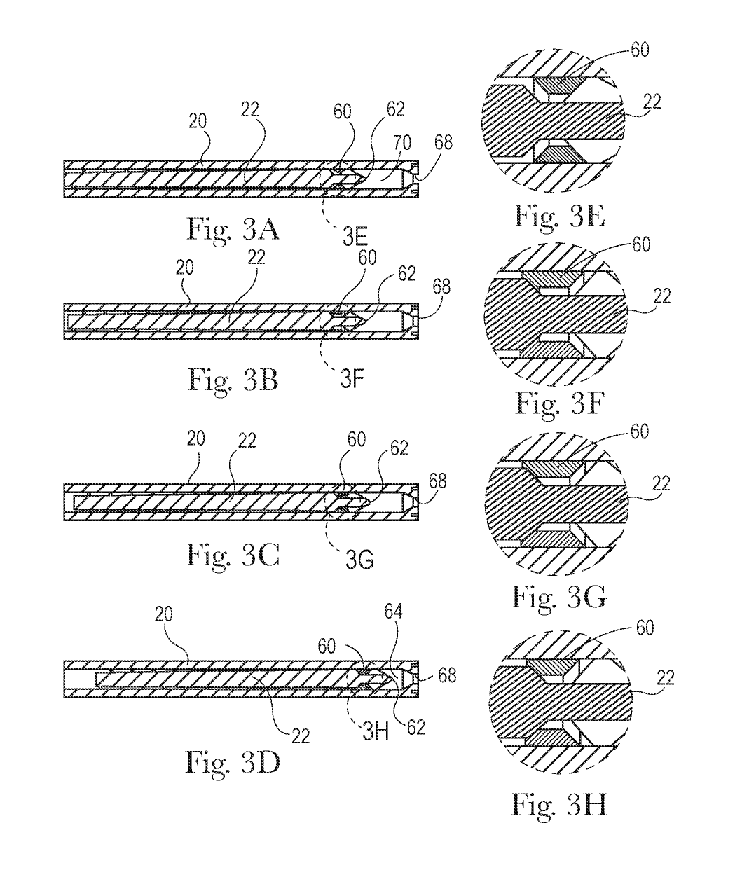

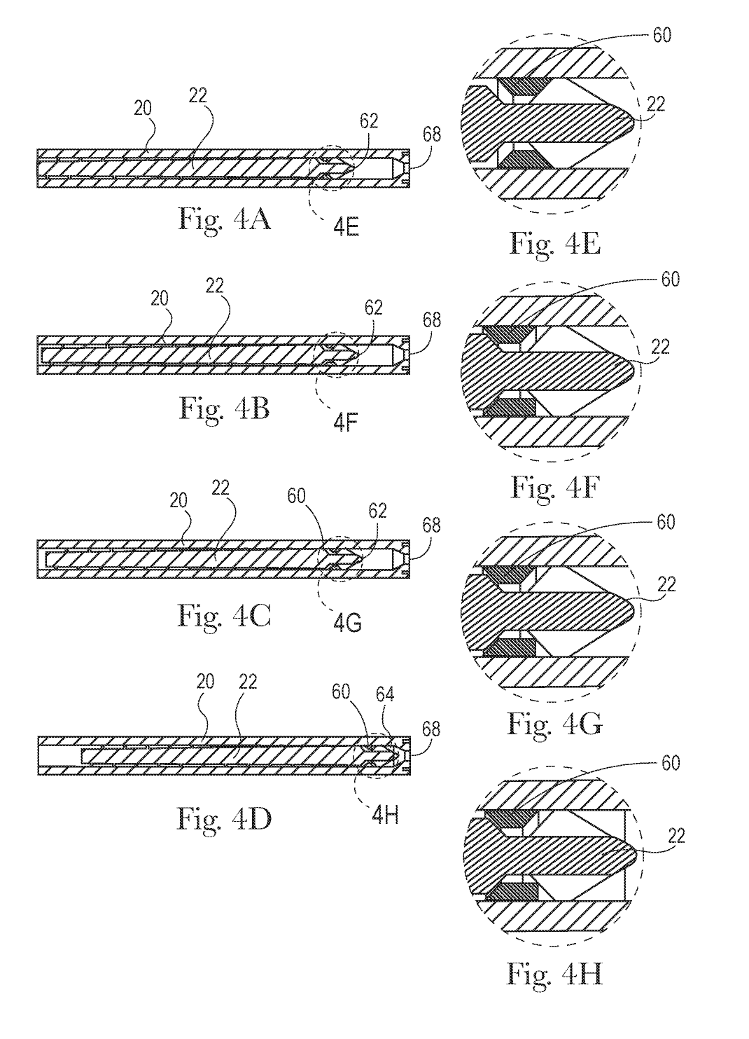

FIGS. 3A-3H and 4A-4H illustrate one example of how the injection molding apparatus 10 described above can be used to provide a substantially controlled molding process even when the check ring 60 is or becomes “leaky.” FIGS. 3A-3H illustrate a first injection molding cycle of an injection molding run, while FIGS. 4A-4H illustrate a second injection molding cycle of the same injection molding run, the second injection molding cycle being performed subsequent to the first injection molding cycle.

During the first injection molding cycle illustrated in FIGS. 3A-3H, the injection molding apparatus 10 is used to make a particular injection molded part by injecting a first shot 70 of the molten thermoplastic material 24 into the mold cavity 32 via the reciprocating screw 22, which is arranged in the barrel 20, and to which the check ring 60 is attached. The injection molding apparatus 10 is, during the first cycle, controlled according to a particular, pre-determined mold cycle that maintains a substantially constant melt pressure in the nozzle and according to a first particular target shot size for the molten thermoplastic material 24. The check ring 60 illustrated in FIGS. 3A-3H is operating or functioning normally, i.e., is not leaking. As such, the check ring 60 is, during the first injection cycle, allowing a first or limited backflow equal to less than 5% of the first particular target shot size. The first or limited backflow may be equal to less than 5%, less than 4%, less than 3%, less than 2%, or less than 1% of the target shot size for the molten thermoplastic material 24.

During the second injection molding cycle illustrated in FIGS. 4A-4H, the injection molding apparatus 10 is used to make the same injection molded part by injecting a second shot 72 of the molten thermoplastic material 24 into the mold cavity 32 via the reciprocating screw 22. The injection molding apparatus 10 is, during the second cycle, controlled according to the same particular, pre-determined mold cycle as the first cycle. The injection molding apparatus 10 is, however, controlled according to a second particular target shot size for the molten thermoplastic material 24, with the second particular target shot size being larger than the first particular target shot size. The second particular target shot size may, for example, be 5% to 30% greater than the first particular target shot size, 5% to 25% greater than the first particular target shot size, 5% to 20% greater than the first particular target shot size, 5% to 15% greater than the first particular target shot size, or within some other range of percentages.

The check ring 60 illustrated in FIGS. 4A-4H is leaking, i.e., allowing a second backflow greater than the first backflow and in excess of 5% of the second particular target shot size. The second backflow may, as an example, be equal to 5% to 20% of the second particular target shot size, 5% to 15% of the second particular target shot size, 5% to 10% of the second particular target shot size, or within some other range of percentages. The fact that the check ring 60 is leaking may, in some cases, be determined after the first injection molding cycle but prior to the second injection molding case. Such a determination may be based on one or more end positions for the reciprocating screw 22, based on a calculated amount of the backflow being allowed by the check ring 60, and/or based on quality data, such as part weight, for the molded part.

It will be appreciated that the second particular target shot size may be manually set, e.g., by providing an input to the controller 50, or may be automatically set by the controller 50 without any sort of input thereto. The second particular target shot size may be set based on an amount of backflow of the molten thermoplastic material 24 allowed by the check ring 60. As an example, the second particular target shot size may be larger when the amount of backflow of the molten thermoplastic material 24 allowed by the check ring 60 is larger. Additional target shot sizes, e.g., for use in third, fourth, and so on injection molding cycles, may also be set. These additional target shot sizes may, like the second particular shot size, be set based on an amount of backflow of the molten thermoplastic material 24 allowed by the check ring 60.

In spite of the fact that the check ring 60 is “leaking,” the injection molding apparatus 10 described herein can continue to be used to perform subsequent injection molding cycles as part of the same injection molding run, all while continuing to make or yield production versions of the same injection molded part.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of injection molding, the method comprising:
during a first injection molding cycle of an injection molding run, using an injection molding apparatus to make a particular injection molded part by injecting a first shot of a molten thermoplastic material into a mold cavity of a mold of the injection molding apparatus via a reciprocating screw in a barrel, with a check ring attached to the screw, wherein:
the first injection molding cycle includes controlling the injection molding apparatus according to a particular predetermined mold cycle that maintains a substantially constant melt pressure in a nozzle of the apparatus;
the substantially constant melt pressure fluctuates up or down by less than 30%;
the substantially constant melt pressure is maintained for 30% to 95% of the filling of the mold cavity;
the first injection molding cycle includes controlling the injection molding apparatus according to a first particular target shot size; and
the check ring allows a limited backflow of the molten thermoplastic material,
wherein the limited backflow is less than 5% of the first particular target shot size; and
during a second injection molding cycle of the injection molding run, subsequent to the first injection molding cycle, using the injection molding apparatus to make the particular injection molded part by injecting a second shot of the molten thermoplastic material into the mold cavity of the mold of the injection molding apparatus via the reciprocating screw in the barrel, with the check ring attached to the screw, wherein:
the second injection molding cycle includes controlling the injection molding apparatus according to the particular predetermined mold cycle; and
the second injection molding cycle includes controlling the injection molding apparatus according to a second particular target shot size, which is greater than the first particular shot size;
the check ring allows a high backflow of the molten thermoplastic material, wherein the high backflow is 5% to 20% of the second particular target shot size; and
continuing to use the injection molding apparatus in the injection molding run to make production versions of the injection molded part, according to the second injection molding cycle, wherein the check ring continues to allow the high backflow of the molten thermoplastic material.

2. The method of claim 1, wherein during the first injection molding cycle of the injection molding run, the substantially constant melt pressure fluctuates up or down by less than 20%.

3. The method of claim 1, wherein during the first injection molding cycle of the injection molding run, the substantially constant melt pressure fluctuates up or down by less than 10%.

4. The method of claim 1, wherein during the first injection molding cycle of the injection molding run, the substantially constant melt pressure is maintained for 50% to 95% of the filling of the mold cavity.

5. The method of claim 1, wherein during the first injection molding cycle of the injection molding run, the substantially constant melt pressure is maintained for 70% to 95% of the filling of the mold cavity.

6. The method of claim 1, wherein during the second injection molding cycle of the injection molding run, the second injection molding cycle includes controlling the injection molding apparatus according to a second particular target shot size, which is 5% to 30% greater than the first particular shot size.

7. The method of claim 1, wherein during the second injection molding cycle of the injection molding run, the second injection molding cycle includes controlling the injection molding apparatus according to a second particular target shot size, which is 5% to 20% greater than the first particular shot size.

8. The method of claim 1, wherein during the second injection molding cycle of the injection molding run, the check ring allows the high backflow of the molten thermoplastic material, the check ring allows a high backflow of the molten thermoplastic material, wherein the high backflow is 5% to 15% of the second particular target shot size.

9. The method of claim 1, wherein during the second injection molding cycle of the injection molding run, the check ring allows the high backflow of the molten thermoplastic material, the check ring allows a high backflow of the molten thermoplastic material, wherein the high backflow is 5% to 10% of the second particular target shot size.

10. The method of claim 1, including, after the first injection molding cycle but before the second injection molding cycle, determining that the check ring is allowing the high backflow.

11. The method of claim 1, including determining that the check ring is allowing the high backflow, based on one or more end positions for the reciprocating screw.

12. The method of claim 1, including manually setting the second particular target shot size, by providing an external controller input.

13. The method of claim 1, including automatically setting the second particular target shot size, without providing an external controller input.

14. The method of claim 1, including automatically setting the second particular target shot size, based on an amount of backflow of the molten thermoplastic material allowed by the check ring.

15. The method of claim 1, including setting additional target shot sizes for injection molding cycles in the injection molding run, wherein the setting for each additional target shot size is based on a calculated amount of backflow of the molten thermoplastic material allowed by the check ring.

16. The method of claim 15, wherein the setting includes increasing a target shot size for a larger calculated amount of the backflow.

17. The method of claim 1, wherein:
during the first injection molding cycle of the injection molding run, using the injection molding apparatus to make the particular injection molded part by injecting the first shot of the molten thermoplastic material into the mold cavity of the mold, wherein the first injection molding cycle has a first cushion of the molten thermoplastic material, measured from a front of the check ring to an end of the barrel at an end of the first injection molding cycle; and
during the second injection molding cycle of the injection molding run, using the injection molding apparatus to make the particular injection molded part by injecting the second shot of the molten thermoplastic material into the mold cavity of the mold, wherein the second injection molding cycle has a second cushion of the molten thermoplastic material, measured from the front of the check ring to the end of the barrel at an end of the second injection molding cycle, and wherein the second cushion has a second size that is 80% to 120% of a first size of the first cushion.

18. The method of claim 15, wherein the second size is 90% to 110% of the first size.

19. The method of claim 1, wherein the continuing to use includes the injection molding apparatus providing an operator warning related to the high backflow condition, but continuing to make the particular injection molded part while the operator warning is being provided.
